(19) United States
(12) Patent Application Publication
(10) Pub. No.: US 2009/0094585 A1
(43) Pub. Date: Apr. 9, 2009

(54) METHOD AND APPARATUS FOR ANALYZING EXPLOIT CODE IN NONEXECUTABLE FILE USING VIRTUAL ENVIRONMENT

(76) Inventors: Young Han CHOI, Daejeon (KR); Hyoung Chun KIM, Daejeon (KR); Do Hoon LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/056,434

(22) Filed: Mar. 27, 2008

(30) Foreign Application Priority Data
Oct. 4, 2007 (KR) 10-2007-0100009

(51) Int. Cl. G06F 9/44

(52) U.S. Cl. 717/131

(57) ABSTRACT

Provided is a method and apparatus for analyzing an exploit code included in a nonexecutable file using a target program with vulnerability in a virtual environment. The method includes the steps of: loading a nonexecutable file including the exploit code by a target program, the target program being executed in a virtual environment and includes vulnerability; analyzing a register value of the target program and determining if the register value of the target program indicates a normal code region; storing log information on operation of the target program when the register value indicates a region other than the normal code region; and extracting and analyzing the exploit code included in the nonexecutable file based on the stored log information. In this method, the exploit code is analyzed in the virtual environment, thereby preventing damage caused by execution of the exploit code.

### CROSS-REFERENCE TO RELATED APPLICATION

This application claims priority to and the benefit of Korean Patent Application No. 2007-100009, filed Oct. 4, 2007, the disclosure of which is incorporated herein by reference in its entirety.

### BACKGROUND

1. Field of the Invention

The present invention relates to a method and apparatus for analyzing an exploit code and, more particularly, to a method and apparatus for analyzing an exploit code using a virtual environment.

2. Discussion of Related Art

In recent years, information security has mainly been threatened by exploit codes (or malicious codes), which have generally given rise to problems in terms of information security purposes, that is, confidentiality, integrity, and availability.

An exploit code may be theoretically defined as any program or executable portion made to do damage to other computers, and may be substantially defined as any program or executable portion made to do psychological and other substantial damage to other people.

Methods of analyzing exploit codes may be classified into methods of analyzing well-known exploit codes and methods of analyzing unknown exploit codes.

The methods of analyzing well-known exploit codes may include a signature-based detection method, a cyclic redundancy check (CRC) method, and a heuristic detection method.

In the signature-based detection method, as a person is identified by his or her signature, a vaccine program examines a virus by analyzing an exploit code using a string of characters peculiar to the exploit code. Signature-based detection methods may be divided into a sequential string detection method and a specific string detection method. The sequential string detection method is performed at high speed, but it exhibits a low detection rate. In contrast, the specific string detection method results in detecting exploit codes at a high rate, but it is performed at low speed.

The CRC method is a kind of an error check method that inspects the reliability of data in serial transmission. The CRC method exhibits a low rate of false detection, however when only a byte of data is transformed, exploit codes cannot be detected.

The heuristic detection method, which is proposed to make up for the signature-based detection method, searches for a special command or operating state that cannot be found in common programs. However, it is very difficult to embody a system according to the heuristic detection method.

Meanwhile, the methods of analyzing unknown exploit codes may be categorized as either a behavior-based detection method or an immune system.

In the behavior-based detection method, when an execution program hooks into a system-level call, compares the system-level call with a system-level call database (DB) retained in its own search engine if the system-level call is against no-hooking rules. If it is, it is determined that the corresponding execution program is an exploit code. In this approach, false detection for a specific system-level call may occur due to poly setting errors, so that it is likely to determine that a normal execution code is an exploit code.

The immune system is directed to solving security of a computer system by self/nonself discrimination, like in a natural immune system. However, since this immune system leads to a high rate of false detection, it is not yet commercialized.

Therefore, it is necessary to develop a method of extracting exploit codes securely and precisely by overcoming the problems of the above-described conventional methods.

### SUMMARY OF THE INVENTION

The present invention is directed to a method and apparatus for analyzing an exploit code included in a nonexecutable file using a target program with vulnerability in a virtual environment.

Also, the present invention is directed to a method and apparatus for analyzing an exploit code, wherein a target program is continuously monitored and information on a point in time when an exploit code is executed is stored as a log and analyzed.

Furthermore, other objects of the present invention will be understood by the following description and exemplary embodiments of the present invention.

One aspect of the present invention provides a method of analyzing an exploit code. The method includes the steps of: loading a nonexecutable file including the exploit code by a target program that is executed in a virtual environment and includes vulnerability; analyzing a register value of the target program and determining if the register value of the target program indicates a normal code region; storing log information on operation of the target program when the register value indicates a region other than the normal code region; and extracting and analyzing the exploit code included in the nonexecutable file based on the stored log information.

Another aspect of the present invention provides an apparatus for analyzing an exploit code, including: a program execution unit for loading a nonexecutable file including an exploit code via a target program and continuously outputting a register value of the target program, the target program being executed in a virtual environment and including vulnerability; a program execution analysis unit for analyzing the register value output from the program execution unit and storing log information on operation of the target program in a log information DB when the register value indicates a region other than a normal code region; and an exploit code analysis unit for extracting and analyzing the exploit code included in the nonexecutable file based on the stored log information.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an exploit code analysis apparatus according to an exemplary embodiment of the present invention;

FIG. 2 is a flowchart illustrating a method of analyzing an exploit code according to an exemplary embodiment of the present invention; and

FIG. 3 is a diagram for explaining an example of a method of analyzing an exploit code according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. Also, a detailed description of known functions and constructions that may make the scope of the invention unclear will be omitted here.

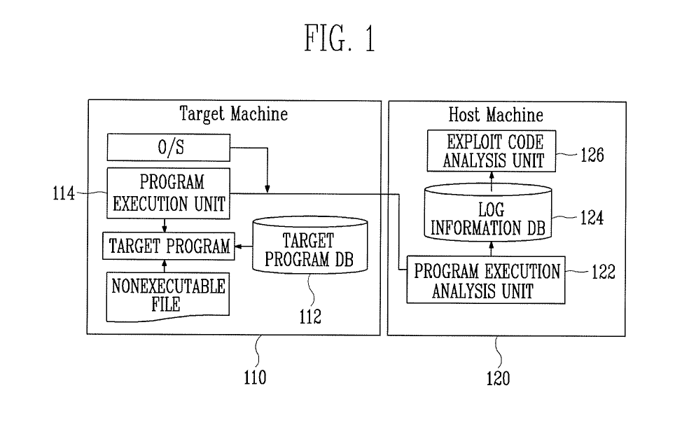

Hereinafter, an exploit code analysis apparatus according to an exemplary embodiment of the present invention will be described in detail with reference to FIG. 1.

Referring to FIG. 1, the exploit code analysis apparatus includes a target machine 110 and a host machine 120. The target machine 110 loads a nonexecutable file including an exploit code via a target program including vulnerability and executes the target program. The host machine 120 extracts and analyzes the exploit code using information output from the target machine 110.

The nonexecutable file refers to a data file that cannot be executed on its own. When the nonexecutable file including an exploit code is loaded by a program with vulnerability and the program deviates from a steady flow, the exploit code is executed.

The exploit code is executed when the program deviates from the steady flow due to the vulnerability of the program. In the case of an exploit code with many malicious functions, an exploit code image that is included beforehand in a nonexecutable file is executed. The exploit code image is an execution file that may or may not be inserted in the nonexecutable file according to the exploit code.

In the present embodiment, the target machine 110 includes a target program database (DB) 112 and a program execution unit 114.

The target program DB 112 stores a program with various types of vulnerabilities, which is required to execute the nonexecutable file for detecting the exploit code.

The program execution unit 114 loads an externally input nonexecutable file via a target program including vulnerability, which is executed in a virtual environment. In this case, the program execution unit 114 searches the target program DB 112 to select a target program that can execute the nonexecutable file based on the type of the nonexecutable file.

Also, the program execution unit 114 outputs a register value of the target program by which the nonexecutable file is loaded and executed to a program execution analysis unit 122.

In the present embodiment, the host machine 120 includes a program execution analysis unit 122, a log information DB 124, and an exploit code analysis unit 126.

The program execution analysis unit 122 analyzes the register value output from the program execution unit 114 and determines if the register value indicates a region other than a normal code region of a virtual memory. When it is determined that the register value indicates the region other than the normal code region, the program execution analysis unit 122 stores information on the operation of the target program in the log information DB 124. For example, when the target program is an x86 central processing unit (CPU), the moment an extended instruction pointer (EIP) register value indicates a region outside a normal code region, log information on the operation of the x86 CPU is stored in the log information DB 124. The program execution analysis unit 122 may obtain information on the operation of the target program for the log information from an operating system (O/S) of the target machine 110.

Specifically, the program execution analysis unit 122 continuously monitors the target program and analyzes the register value of the target program so that a point in time when the exploit code included in the nonexecutable file is executed is stored as log information. Therefore, according to the present invention, the point in time when the exploit code is executed is stored as the log information and thus, not only a known exploit code but also an unknown exploit code can be extracted and analyzed.

A normal code refers to a code memory region to which a program by which a file is loaded normally makes access. Meanwhile, the log information includes the register value of the target program and the content of the nonexecutable file loaded in the virtual memory.

In the present embodiment, the program execution analysis unit 122 analyzes the register values, which are continuously output from the program execution unit 114, so that it may start to store the log information at a point in time when the register value indicates the region other than the normal code region, and finish storing the log information at a point in time when the register value indicates the normal code region.

The log information DB 124 stores the log information output from the program execution analysis unit 122.

The exploit code analysis unit 126 extracts and analyzes the exploit code included in the nonexecutable file based on the log information stored in the log information DB 124. In this case, the exploit code analysis unit 126 disassembles the extracted exploit code so that it can analyze the operating mechanism of the exploit code.

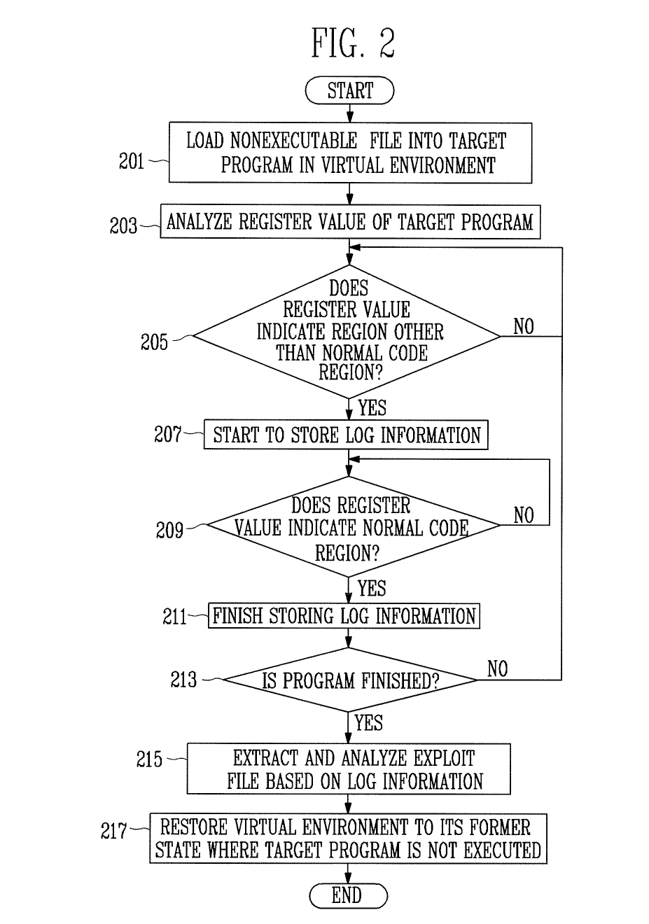

Hereinafter, a method of analyzing an exploit code according to an exemplary embodiment of the present invention will be described with reference to FIGS. 1 and 2.

In step 201, when a nonexecutable file is input to extract an exploit code, the program execution unit 114 loads the nonexecutable file via a target program that is executed in a virtual environment. In this case, the program execution unit 114 searches the target program DB 112 and can select a target program capable of executing the nonexecutable file based on the type of the nonexecutable file. The target program parses the nonexecutable file and loads the nonexecutable file in a virtual memory.

In step 203, the program execution analysis unit 122 analyzes the register values of the target program that are continuously output from the program execution unit 114.

In step 205, the program execution analysis unit 122 determines if the register value of the target program indicates a region other than a normal code region of the virtual memory. When it is determined that the register value of the target program indicates the region other than the normal code region, in other words, when the operation of an exploit code included in the nonexecutable file is detected, the process enters step 207.

Since the exploit code is performed during execution of a program with vulnerability, it is difficult to analyze a point in time when the exploit code is executed. However, according to the present invention, by analyzing the register value of the program in which the nonexecutable file including the exploit code is loaded, a point in time when the exploit code is executed can be easily determined.

In step 207, the program execution analysis unit 122 starts to store log information on the operation of the target program in the log information DB 124. Thereafter, the process enters step 209.

In step 209, the program execution analysis unit 122 determines if the register value of the target program indicates the normal code region. When it is determined that the register value indicates the normal code region, namely, when the exploit code included in the nonexecutable file stops operating, the process enters step 211 so that the program execution analysis unit 122 stops storing the log information.

In step 213, the program execution analysis unit 122 determines if the target program is finished. When it is determined that the target program is finished, the process enters step 215. When it is determined that the target program is not finished, the process enters step 205 to continue analyzing the register value of the target program.

In step 215, the exploit code analysis unit 126 extracts and analyzes the exploit code included in the nonexecutable file using the log information stored in the log information DB 124, restores the virtual environment to its former state where the target program is not executed, and finishes the process (step 217).

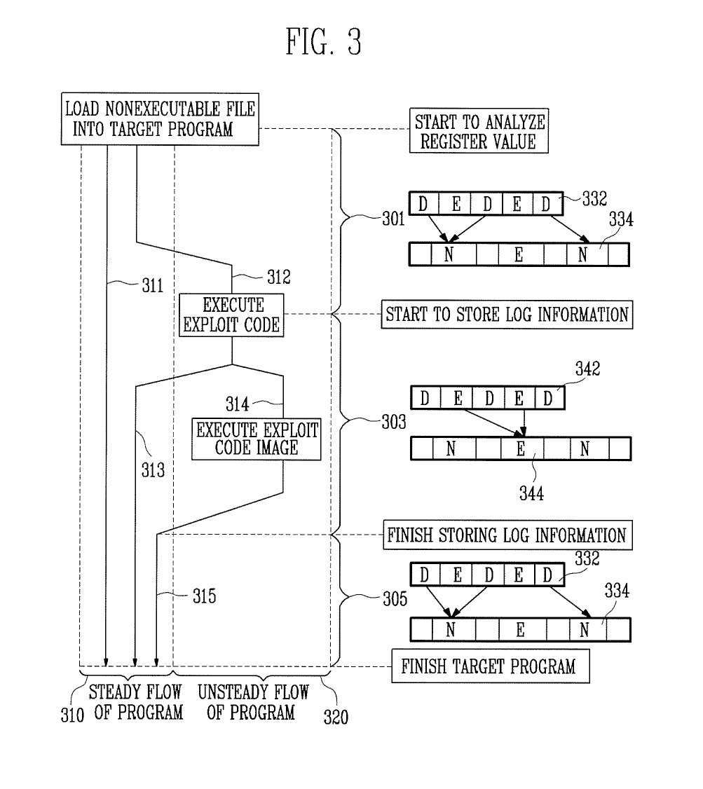

Hereinafter, an example of a method of analyzing an exploit code according to an exemplary embodiment of the present invention will be described with reference to FIGS. 1 and 3.

When a target program with vulnerability is executed, the target program may be executed with a steady flow 310 from start to finish, however it may be executed with an unsteady flow 320 due to the vulnerability.

When a nonexecutable file is loaded by the target program, the program execution analysis unit 122 starts to analyze a register value of the target program. A period 301 is between a point in time when the nonexecutable file is loaded by the target program and a point in time when an exploit code is executed. In this case, the register value of the target program, i.e., a data code 332, indicates a normal code region 334 of a virtual memory.

When the target program deviates from the steady flow due to vulnerability (refer to 312), the exploit code included in the nonexecutable file loaded in the target program may be executed. In this case, an exploit code image may be executed (refer to 314) according to the type of the exploit code.

In a period 303 where the exploit code is executed, the register value of the target program indicates a region 344 other than the normal code region 334 of the virtual memory due to the execution of the exploit code. In this case, the program execution analysis unit 122 starts to store log information.

Thereafter, the target program deviates from the unsteady flow 320 (refer to 313 and 315), so that the register value of the target program, i.e., the data code 332, indicates the normal code region 334 of the virtual memory again in a period 305 where the exploit code is not executed. In this case, the program execution analysis unit 122 finishes storing the log information, and the exploit code analysis unit 126 extracts and analyzes the exploit code based on the stored log information.

According to the present invention as described above, an exploit code is analyzed in a virtual environment, thereby preventing damage caused by execution of the exploit code.

Also, it is possible to extract and analyze not only a known exploit code but also an unknown exploit code.

In the drawings and specification, there have been disclosed typical preferred embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method of analyzing an exploit code, the method comprising:
loading a nonexecutable file including the exploit code by a target program, the target program being executed in a virtual environment and including vulnerability;
analyzing a register value of the target program and determining if the register value of the target program indicates a normal code region;
storing log information on operation of the target program when the register value indicates a region other than the normal code region; and
extracting and analyzing the exploit code included in the nonexecutable file based on the stored log information.

2. The method according to claim 1, wherein the storing of the log information comprises continuously analyzing the register value, starting storing the log information at a point in time when the register value starts to indicate the region other than the normal code region and finishing storing the log information at a point in time when the register value starts to indicate the normal code region.

3. The method according to claim 2, wherein the analyzing of the register value of the target program and the storing of the log information is repeatedly performed until the target program is finished.

4. The method according to claim 1, further comprising restoring the virtual environment to a former state where the target program is not executed, after extracting and analyzing the exploit code.

5. The method according to claim 1, wherein the log information comprises the register value of the target program and contents of the nonexecutable file loaded in a virtual memory.

6. An apparatus for analyzing an exploit code, comprising:
a program execution unit for loading a nonexecutable file including an exploit code via a target program and continuously outputting a register value of the target program, the target program being executed in a virtual environment and includes vulnerability;
a program execution analysis unit for analyzing the register value output from the program execution unit and storing log information on operation of the target program in a log information DB when the register value indicates a region other than a normal code region; and
an exploit code analysis unit for extracting and analyzing the exploit code included in the nonexecutable file based on the stored log information.

7. The apparatus according to claim 6, wherein the program execution analysis unit analyzes the register value that is continuously output from the program execution unit, and starts storing the log information at a point in time when the register value starts to indicate the region other than the normal code region and finishes storing the log information at a point in time when the register value starts to indicate the normal code region.

8. The apparatus according to claim 6, wherein the exploit code analysis unit restores the virtual environment to a former state where the target program is not executed, after analyzing the exploit code.

9. The apparatus according to claim 6, wherein the log information comprises the register value of the target program and contents of the nonexecutable file loaded in the virtual memory.
